(19) United States
(12) Patent Application Publication
(10) Pub. No.: US 2018/0283791 A1
(43) Pub. Date: Oct. 4, 2018

(54) WORKPIECE CARRIER AND METHOD FOR ITS PRODUCTION

(71) Applicant: SCHUNK KOHLENSTOFFTECHNIK GMBH, Heuchelheim (DE)

(72) Inventors: Bjoern Pfeffer, Mittenaar (DE); Bernd Groos, Wehrheim (DE)

(21) Appl. No.: 15/924,466

(22) Filed: Mar. 19, 2018

(30) Foreign Application Priority Data
Mar. 24, 2017 (DE) 10 2017 205 046.2

(51) Int. Cl. F27D 5/00; C21D 9/00; C21D 9/40

(52) U.S. Cl. CPC F27D 5/0018; C21D 9/40; F27D 5/0012; C21D 9/0025

(57) ABSTRACT

A workpiece carrier and method for producing a workpiece carrier (10) for providing and handling workpieces in high-temperature ovens for high-temperature treatment or similar, said workpiece carrier being made of a support grid (11) having workpiece holders (12) for positioning workpieces on the workpiece carrier, said support grid being made of support struts (14, 15, 16, 17, 19, 20) forming a grid structure (21), said support struts being made of carbon fiber-reinforced carbon (CFC), said workpiece holders being made of positioning devices (22) of the work-piece carrier arranged on the support struts, said positioning devices being arranged on the support struts such that the workpiece can be arranged on the workpiece holder in a predetermined position, said positioning devices comprising a bearing element (24) made of a ceramic fiber composite material, said positioning device being a support element (23) arranged on a support strut for arranging the bearing element.

This application claims the benefit of German Patent Application no. 10 2017 205 046.2 filed Mar. 24, 2017, the disclosure of which is incorporated herein by reference.

### TECHNICAL FIELD

The invention relates to a workpiece carrier as well as to a method for producing a workpiece carrier for providing and handling workpieces in high-temperature ovens for high-temperature treatment or similar, said workpiece carrier being made of a support grid having workpiece holders for positioning workpieces on the workpiece carrier, said support grid being made of support struts forming a grid structure, said support struts being made of carbon fiber-reinforced carbon (CFC), said workpiece holders being made of positioning devices of the workpiece carrier arranged on the support struts, said positioning devices being arranged on the support struts and being realized in such a manner that workpieces can be arranged on the workpiece holders in a predetermined position.

### BACKGROUND

Such workpiece carriers are sufficiently known and are commonly used for holding and transporting workpieces in the scope of high-temperature treatments. In this context, a high-temperature treatment is understood to be a workpiece treatment in a high-temperature oven at a temperature exceeding 1,000° C. Workpieces made of metal, for example steel, are annealed in the scope of the high-temperature treatment, for example, in order to improve the properties of the respective workpiece. In the known treatment methods, it is continually attempted to arrange a large number of workpieces on workpiece carriers such that an interior space of a high-temperature oven is filled as densely as possible in order to keep the costs for the treatment method low. For this purpose, the workpieces are arranged such on the workpiece carrier that the workpieces are exposed to an oven atmosphere on all sides if possible in order to attain a homogenous heating of the respective workpieces.

The workpiece carriers are regularly made of a support grid which is made up of support struts which in turn form a grid structure. It is also known to make the support struts of metal; however, the metal support struts can slightly distort at high temperatures or sag. Support struts made of carbon fiber-reinforced carbon (CFC), in contrast, are dimensionally stable and sufficiently hard. Positioning devices can be arranged on the support struts and form workpiece holders. Thus, it becomes possible to arrange a plurality of workpieces on the workpiece carrier in a predetermined position.

During a high-temperature treatment of workpieces, it must be ensured that the material of the workpiece carrier does not contaminate the material of the workpiece. A carburization of steel as a material of a workpiece can thus be the unintended result, for example, if this material directly rests against a positioning device made of carbon fiber-reinforced carbon. It is therefore known to provide workpieces with so-called separating layers. A separating layer can consist of a ceramic material and be applied on the workpiece carrier by applying a coating or by means of plasma spraying. However, this is disadvantageous since such coatings can easily crack and chip off owing to the different thermal expansion coefficients of carbon fiber-reinforced carbon and ceramic materials. Furthermore, coatings can be mechanically worn due to a repeated use of the workpiece carrier, wearing the workpiece carrier out after some time.

From DE 20 2013 011 806 U1, a workpiece carrier is known which comprises a plurality of positioning devices arranged on a support grid, said positioning devices being realized as ceramic rods which are held in support struts of the support grid arranged perpendicular to the rods and provided with holding grooves. The rods are made of an extruded ceramic material and are not resistant to thermal shock, meaning the rods can be easily damaged during quick changes in temperature by forming cracks. They are also very brittle and liable to breakage.

The object of the invention at hand is to propose a workpiece carrier and a method for producing a workpiece carrier by means of either of which a thermal treatment of a workpiece can be reliably conducted.

### SUMMARY

This object is attained by a workpiece carrier having the features of claim 1, a workpiece carrier construction set having the features of claim 15 and a method for producing a workpiece carrier having the features of claim 16.

The workpiece carrier according to the invention for providing and handling workpieces in high-temperature ovens for high-temperature treatment or similar is made of a support grid having workpiece holders for positioning workpieces on the workpiece carrier, said support grid being made of support struts forming a grid structure, said support struts being made of carbon fiber-reinforced carbon (CFC), said workpiece holders being made of positioning devices of the workpiece carrier arranged on the support struts, said positioning devices being arranged on the support struts and being realized such that workpieces can be arranged on the workpiece holders in a predetermined position, said positioning device comprising a bearing element for arranging workpieces, said bearing element being made of a ceramic fiber composite material, said positioning device comprising a support element arranged on a support strut for arranging the bearing element.

Accordingly, the bearing element of the positioning device is realized for arranging workpieces and is directly contacted therewith. Owing to the fact that the bearing element is made of a ceramic fiber composite material, it is thicker than a simple coating so that it almost cannot be mechanically worn. Simultaneously, it is very stable due to the fiber reinforcement, i.e. not brittle, and resistant to quick changes in temperature. Furthermore, a contamination of workpieces by carbon from the support grid can be prevented by the workpieces abutting exclusively against the bearing elements. Since producing an abutment element made of ceramic fiber composite material is significantly more costly than a production using carbon fiber-reinforced carbon, it becomes possible by advantageously arranging the bearing element on the support element of the positioning device to produce the bearing element using little material and thus also inexpensively. The support element arranged on the support strut accordingly serves to mount or rather hold the bearing element consisting of the ceramic fiber composite material on the support strut or support struts. The bearing element does not have to be realized so stably so as to be able to carry a weight of the respective workpiece on its own. Owing to this, it becomes possible to form the bearing element by using only few ceramic fiber composite materials and thus inexpensively.

Advantageously, the ceramic fiber composite material can be made of an oxide ceramic, preferably an inorganic matrix made of aluminum oxide, mullite, zirconium oxide, silicon carbide or silicon nitride. Such materials are particularly suitable for producing a ceramic fiber composite material.

Furthermore, the ceramic fiber composite material can be made of inorganic fibers, preferably reinforcing fibers made of aluminum oxide, mullite, zirconium oxide, silicon carbide or silicon nitride. The inorganic fibers can be combined with an oxide ceramic matrix made of a coinciding or a different material. Furthermore, it can be intended to combine inorganic fibers made of different materials with each other.

The fibers can form a fiber composite, preferably a unstructured, wound or interweaved fiber composite. The fiber composite can be a textile non-crimp fabric, for example. It can also be intended to form a fiber composite by winding fibers on a mandrel and subsequently cutting the fibers along a longitudinal axis of the mandrel. Furthermore, filament yarns of 3,000 den (denier), 10,000 den or 20,000 den can be processed into woven fabrics which are then processed into the ceramic fiber composite material. A fiber felt or a fiber fleece can be used as a unstructured fiber composite.

The bearing elements can be arranged parallel to each other. Hence, a number of parallel rows of workpiece holders can be formed on the workpiece carrier. The bearing elements can be spaced from each other in such a manner that workpieces can be held in a row arrangement between two bearing elements on the workpiece carrier, for example. The support elements can consequently also be arranged parallel to each other. The support struts can then also extend parallel or perpendicular to the support elements due to the formed grid structure. Generally, however, it is also possible to form the bearing elements having an arbitrary shape adjusted to the respective workpieces.

It is particularly advantageous if the workpiece holder is formed having a V shape. A formation of the workpiece holder in a V shape enables centering and possibly clamping the respective workpiece in the workpiece holder so as to be able to hold the workpiece particularly securely in the workpiece holder. The workpiece can be a turbine bucket, for example, which forms a V-shaped foot to which the V-shaped workpiece holder is adjusted.

The bearing element can advantageously have a wall thickness of >0.5 mm to <5 mm. Thus it can be ensured that the bearing element is unintentionally worn and that the bearing element is at the same time sufficiently stable. Nevertheless, not so much material is required for the bearing element, significantly driving the costs for the workpiece carrier upward.

The support element can be made of graphite, for example. In order to simplify producing the support element, the graphite can be extruded, shaken or isostatically pressed in conjunction with a binding agent and be formed as the support element after thermal treatment.

The bearing element can form a bearing contour having a bearing surface for arranging workpieces on the bearing element. The bearing contour can be adjusted to the workpiece contour so as to continually ensure that the workpiece exclusively abuts against or is contacted with the bearing surface made of ceramic material. Generally, the bearing contour or rather the bearing surface can be realized having any arbitrary bearing contour adjusted to the workpiece contour.

The support element can form an abutment contour which is adjusted to the bearing contour of the bearing element. The bearing element can consequently be supported against the abutment contour using its entire surface so that the bearing element can be realized very thin. It can also be intended to form the bearing element by being borne on the support element and thus by being adjusted to the abutment contour in its shape in the scope of production.

The support element can be borne or inserted on a support strut, preferably being connected to the support strut in a form-fit manner. One or several grooves can be formed in the support element, for example, which enable(s) inserting the support element on one or more support struts. The corresponding groove essentially corresponds to a thickness of a support strut. Via such a form-fit fixation, it becomes possible to simply remove the support element from the grid structure again as well. The support element can then be quickly exchanged in conjunction with the bearing element when necessary. It also becomes possible, for example, to use an individual support grid for holding different workpieces by exchanging only the support elements which are each adjusted to the different workpieces. It is then no longer required to use support grids directly adjusted to workpieces. Hence, standardized support grids realized identically can be used for different workpieces.

The bearing element can be borne or inserted on the support element, preferably being connected to the support element in a form-fit manner. In particular, it can be intended that the bearing element is borne on the support element in such a manner that the bearing element and the support element can expand without being influenced by the other. It is consequently also possible to choose a material for the support element which has a significantly different thermal expansion coefficient than the material of the bearing element. Nevertheless, it can be intended to fixate the bearing element on the support element in a form-fit manner at a spot as a kind of fixed bearing so that the bearing element cannot be unintentionally displaced on or be removed from the support element.

Advantageously, the bearing element and/or the support element can be profile-shaped. A profile-shaped form considerably simplifies production. It can also be intended to bear several bearing elements, which are formed comparatively shorter than the support element, on the support element.

The support grid can also comprise a support frame made of support struts, said support frame being able to comprise bearing elements made of graphite, said bearing elements being connected via said support struts. The support struts can comprise, for example, slits realized conformingly via which the support struts are connected to each other by inserting them into each other in a crisscross pattern or rather by forming the grid structure. In corner areas of the support frame, for example, or in regular intervals on the support frame, the bearing elements can be made of graphite, into which the support struts can be inserted. By means of the bearing elements, it becomes possible to further stabilize the support frame and to also form a stack arrangement with other support frames if necessary.

The workpiece construction set according to the invention comprises a workpiece carrier according to the invention having a first set of positinning devices and a second set of positioning devices different to the first set, said positioning devices being arranged on the support struts and being realized such that first workpieces and/or second workpieces different to the first workpieces can be arranged on the workpiece holders. Hence, it becomes possible to provide or handle at least two different kinds of workpieces on the workpiece carrier using only one support grid and the first as well as the second set of positioning devices as required. The support grid is realized independently of the workpieces and the respective workpieces are adjusted by means of the corresponding set of positioning devices. The workpiece construction set thus enables a modular usage of different positioning devices, either alone or in combination. Further advantageous embodiments of a workpiece construction set can be derived from the description of features of the dependent claims referring to device claim 1.

In the method according to the invention for producing a workpiece carrier for providing and handling workpieces in high-temperature ovens for high-temperature treatment or similar, the workpiece carrier is made of a support grid and workpiece holders for positioning workpieces on the workpiece carrier, said support grid being made of support struts forming a grid structure, said support struts being made of carbon fiber-reinforced carbon (CFC), said workpiece holders being made of positioning units of the workpiece carrier arranged on the support struts, said positioning devices being arranged on the support struts and being realized in such a manner that workpieces can be arranged on the workpiece holders in a predetermined position, a bearing element of the positioning device for arranging workpieces being made of a ceramic fiber composite material, a support element of the positioning device for arranging the bearing element being arranged on a support strut. With regard to the advantageous effects of the method according to the invention, the description of advantages of the workpiece carrier according to the invention is referred to. Further advantageous embodiments of the method can be derived from the description of features of the dependent claims referring to device claim 1.

### BRIEF DESCRIPTION OF THE DRAWING FIGURES

In the following, preferred embodiments of the invention are further described with reference to the attached drawings.

In the drawings,

FIG. 1 illustrates a workpiece carrier in a perspective view;

FIG. 2 illustrates the workpiece carrier in a top view;

FIG. 3 illustrates a cross-sectional view of a workpiece carrier.

### DETAILED DESCRIPTION

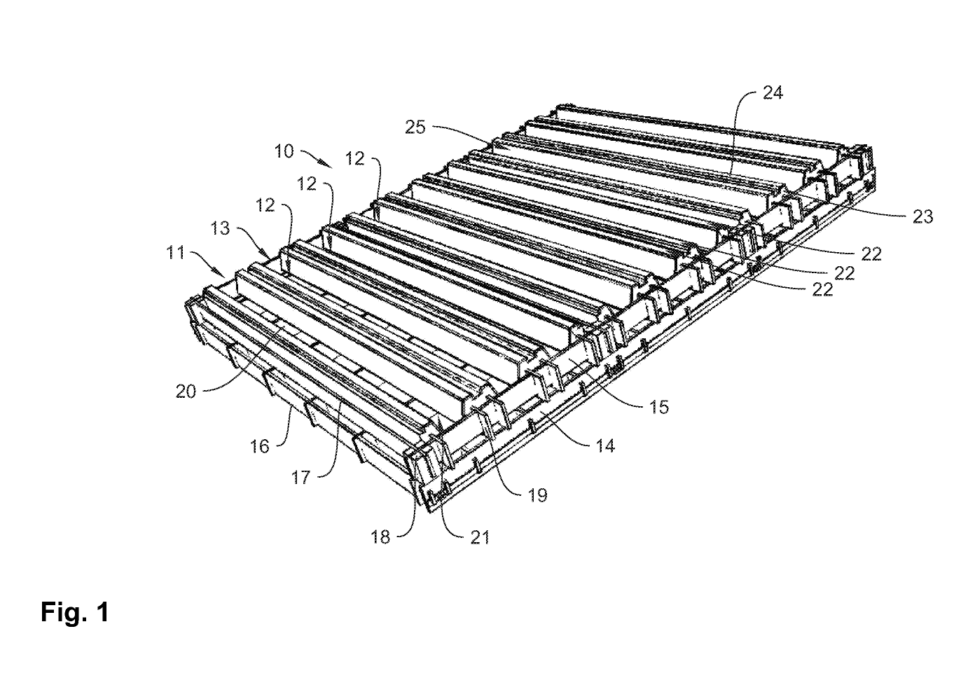

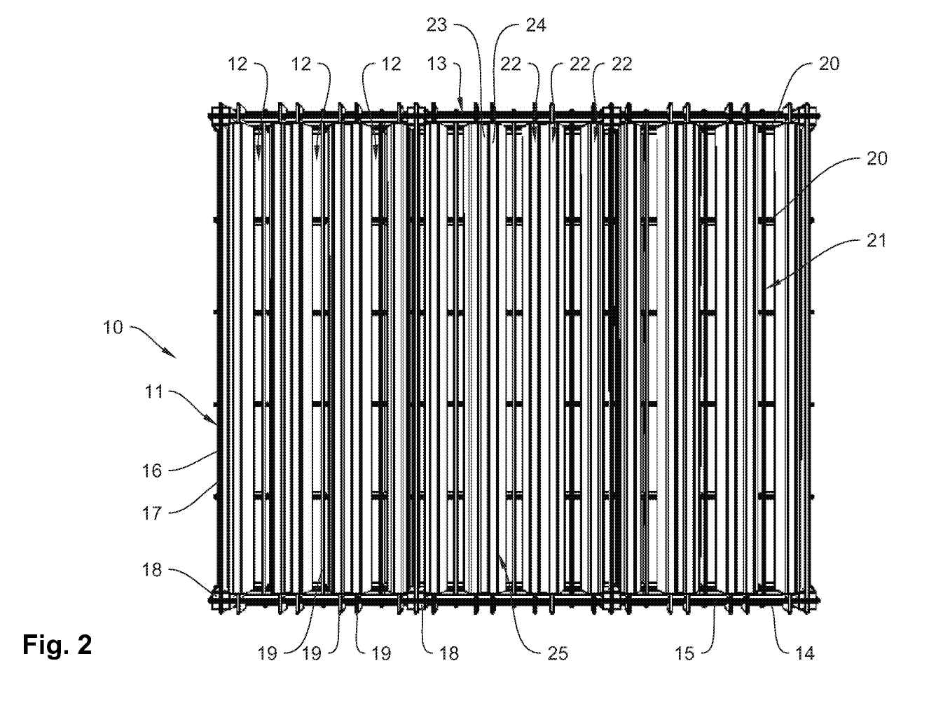

A synopsis of FIGS. 1 and 2 shows a workpiece carrier 10 for providing and handling workpieces in high-temperature ovens. The workpiece carrier 10 is made of a support grid 11 having workpiece holders 12 for positioning workpieces (not illustrated in this instance) on the workpiece carrier 10. The support grid 11 is made of a support frame 13 made of support struts 14, 15, 16, 17 and bearing elements 18 made of graphite. Support struts 19, 20 form a grid structure 21 of the support grid 11. All support struts 14 to 17 and 20, 21 consist of carbon fiber-reinforced carbon (CFC) and are inserted into one another.

The workpiece carrier 10 further comprises positioning devices 22 which are each made of a support element 23 and a bearing element 24. The support element 23 consists of graphite, and the bearing element 24 consists of a ceramic fiber composite material. The support element 23 is inserted on support strut 19 in each instance, the bearing element 24 being inserted on the support element 23. Between the positioning devices 22 arranged parallel, it has become possible to insert workpieces into the thus formed workpiece holders 12, said workpieces being merely contacted with a surface 25 of the bearing element 24. An undesired contamination of workpieces, for example, via a physical contact with components made of carbon can be thus prevented.

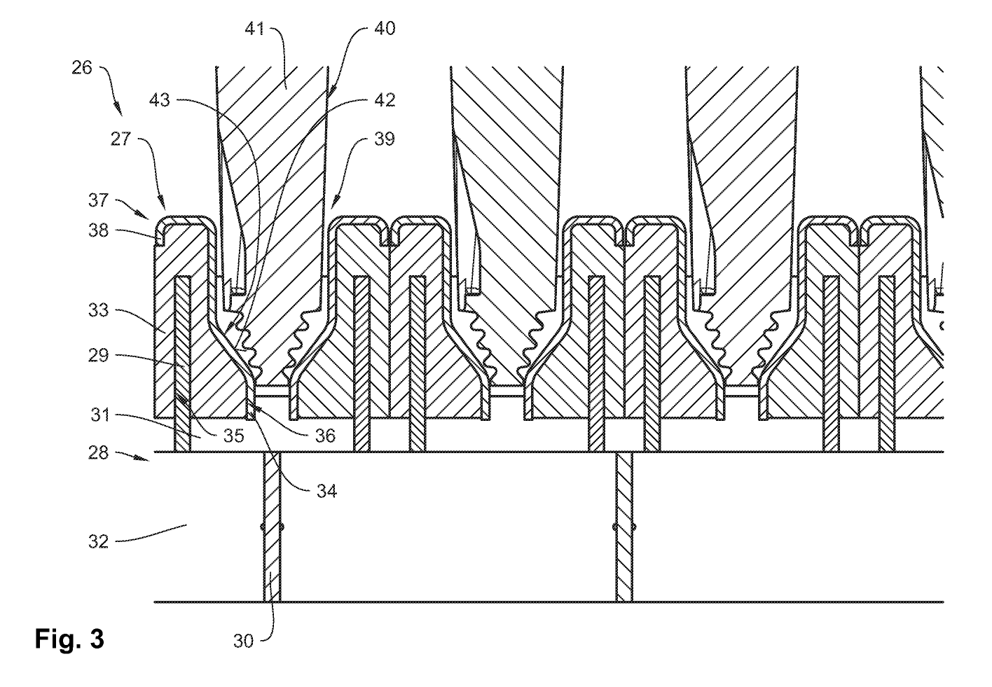

FIG. 3 shows a partial cross-sectional view of a workpiece carrier 26, a cut extending orthogonally to the positioning devices 27 of the workpiece carrier 26, in this instance. A support grid 28 of the workpiece carrier 26 is made of support struts 29, 30, 31 and 32. The support struts 29 to 32 consist of carbon fiber-reinforced carbon (CFC) and are loosely inserted into on another. The positioning devices 27 are made of a support element 33 made of graphite and a bearing element 34 made of a ceramic fiber composite material. The support elements 33 each comprise a longitudinal groove 35 in this instance, by means of which they are inserted on support struts 29. The bearing element 34 is loosely borne on the support element 33 and nestles against an abutment contour 36 of the bearing element 34. A projecting collar 38 is formed on the bearing element 34 at an upper end 37, said collar 38 enabling hooking the bearing element 34 into the support element 33 and thus a form-fit fixation. Nevertheless, a thermal expansion of the bearing element 34 independent from the support element 33 is possible. Between the positioning devices 27 arranged parallel, a workpiece holder 39 is thus formed for turbine buckets 41 realized as exemplary workpieces 40. The bearing elements 34 form a bearing surface 42 for a punctiform abutment of the turbine buckets 41. Accordingly, a bearing contour 43 of a bearing element 34 essentially corresponds to the abutment contour 36 of the support element 33.

1. A workpiece carrier (10, 26) for providing and handling workpieces in high-temperature ovens for high-temperature treatment or similar, said workpiece carrier being made of a support grid (11, 28) having workpiece holders (12, 39) for positioning workpieces on the workpiece carrier, said support grid being made of support struts (14, 15, 16, 17, 19, 20, 29, 30, 31, 32) forming a grid structure (21), said support struts being made of carbon fiber-reinforced carbon (CFC), said workpiece holders being made of positioning devices (22, 27) of the workpiece carrier arranged on the support struts, said positioning devices being arranged on the support struts and being realized in such a manner that workpieces (40) can be arranged on the workpiece holders in a predetermined position,
characterized in that
the positioning device comprises a bearing element (24, 34) for arranging workpieces, said bearing element being made of a ceramic fiber composite material, said positioning device comprising a support element (23, 33) arranged on a support strut for arranging the bearing element.

2. The workpiece carrier according to claim 1,
characterized in that
the ceramic fiber composite material is made of an oxide ceramic, preferably an inorganic matrix of aluminum oxide, mullite, zirconium oxide, silicon carbide or silicon nitride.

3. The workpiece carrier according to claim 1,
characterized in that
the ceramic fiber composite material is made of inorganic fibers, preferably reinforcing fibers made of aluminum oxide, mullite, zirconium oxide, silicon carbide and/or silicon nitride.

4. The workpiece carrier according to claim 3,
characterized in that
the fibers form a fiber composite, preferably an unstructured, wound or interwoven fiber composite.

5. The workpiece carrier according to claim 1,
characterized in that
the bearing elements (24, 34) are arranged parallel to each other.

6. The workpiece carrier according to claim 1,
characterized in that
the workpiece holders (12, 39) are formed having a V-shape.

7. The workpiece carrier according to claim 1,
characterized in that
the bearing element (24, 34) has a wall thickness of >0.5 mm to <5 mm.

8. The workpiece carrier according to claim 1,
characterized in that
the support element (23, 33) is made of graphite.

9. The workpiece carrier according to claim 1,
characterized in that
the bearing element (24, 34) forms a carrier contour (43) having a bearing surface (25, 42) for arranging workpieces (40) on the bearing element.

10. The workpiece carrier according to claim 9,
characterized in that
the support element (23, 33) forms an abutment contour (36) which is adjusted to the bearing contour of the bearing element.

11. The workpiece carrier according to claim 9,
characterized in that
the support element (23, 33) is borne or inserted on a support strut (19, 29), preferably being connected to the support strut in a form-fit manner.

12. The workpiece carrier according to claim 1,
characterized in that
the bearing surface (24, 34) is borne or inserted on the support element (23, 33), preferably being connected to the support element in a form-fit manner.

13. The workpiece carrier according to claim 1,
characterized in that
the bearing element (24, 34) and/or the support element (23, 33) is profile-shaped.

14. The workpiece carrier according to claim 1,
characterized in that
the support grid (11, 28) comprises a support frame (13) made of support struts (14, 15, 16, 17, 19, 20, 29, 30, 31, 32), said support frame comprising bearing elements (18) made of graphite by means of which the support struts (17) are connected.

15. A workpiece carrier construction set comprising a workpiece carrier (10, 26) according to claim 1, having a first set of positioning devices (22, 27) and a second set of positioning devices different to the first set, said positioning devices being able to be arranged on the support struts (19, 29) and being realized in such a manner that first workpieces (40) and/or second workpieces different to the first workpieces can be arranged on the workpiece holders (12, 39).

16. A method for producing a workpiece carrier (10, 26) for providing and handling workpieces in high-temperature ovens for high-temperature treatment or similar, said workpiece carrier being made of a support grid (11, 28) having workpiece holders (12, 39) for positioning workpieces on the workpiece carrier, said support grid being made of support struts (14, 15, 16, 17, 19, 20, 29, 30, 31, 32) forming a grid structure (21), said support struts being made of carbon fiber-reinforced carbon (CFC), said workpiece holders being made of positioning devices (22, 27) of the workpiece carrier made of the support struts, said positioning devices being arranged on the support struts and being realized in such a manner that workpieces (40) can be arranged on the workpiece holders in a predetermined position,
characterized in that
a bearing element (24, 34) of the positioning device for arranging workpieces is made of a ceramic fiber composite material, a support element (23, 33) of the positioning element for arranging the bearing element is arranged on the support strut.
